(19) United States
(12) Patent Application Publication
(10) Pub. No.: US 2026/0265440 A1
(43) Pub. Date: Sep. 10, 2026

(54) PRODUCTION OF FLAME-RETARDENT POLYURETHANE FOAM

(71) Applicant: Evonik Operations GmbH, Essen (DE)

(72) Inventors: Michael SUCHAN, Gelsenkirchen (DE); Carsten SCHILLER, Ratingen (DE)

(73) Assignee: Evonik Operations GmbH, Essen (DE)

(21) Appl. No.: 18/871,928

(22) PCT Filed: Jun. 2, 2023
(86) PCT No.: PCT/EP2023/064765

§ 371 Date: Dec. 5, 2024

(30) Foreign Application Priority Data
Jun. 8, 2022 (WO) PCT/EP2022/065519

(51) Int. Cl. C08G 18/42; C08G 18/08; C08G 18/18; C08G 18/22; C08G 18/40; C08G 18/50; C08J 9/06; C08J 9/14; C08K 3/02; C08K 3/22; C08K 3/32; C08K 3/38; C08K 5/521; C08K 5/5313; C08K 9/10

(52) U.S. Cl. CPC C08G 18/425; C08G 18/5012; C08J 9/06; C08J 9/141; C08J 9/146; C08K 3/2279; C08K 5/521; C08K 5/5313; C08K 9/10; C08G 18/14; C08G 18/1808; C08G 18/225; C08G 18/4018; C08G 18/4202; C08G 18/4216; C08G 2110/0025; C08G 2110/0041; C08J 2203/10; C08J 2203/142; C08J 2203/184; C08J 2205/10; C08J 2207/04; C08J 2375/06; C08J 2375/08; C08K 2003/026; C08K 2003/327; C08K 2003/329; C08K 2003/387

(57) ABSTRACT

Composition for the production of PU foam, preferably rigid PU foam, comprising
at least one halogen-free polyester polyol and at least one halogenated polyol,
at least one physical blowing agent,
at least one flame retardant selected from
(a) the group of the phosphoric acid esters, preferably TCPP, TEP and/or TCEP, especially TCPP and/or TEP,
and/or
(b) the group of the phosphonates, preferably DMMP and/or DMPP,
red phosphorus,
   and at least one polyisocyanate component, wherein the composition has an index of at least 200.

The present invention is in the field of polyurethanes, preferably of polyurethane foams, especially rigid polyurethane foams. It relates in particular to the production of flame-retardant polyurethane foams, preferably flame-retardant rigid polyurethane foams, using a combination of synergistically active constituents, and to compositions for the production of such foams and also to the use of these foams.

Polyurethane (PU) in the context of the present invention is in particular understood to mean a product obtainable by reaction of a polyisocyanate component with a polyol component or compounds having isocyanate-reactive groups. In addition to the polyurethane, further functional groups may also be formed in the reaction, for example uretdiones, carbodiimides, isocyanurates, allophanates, biurets, ureas and/or uretonimines. For the purposes of the present invention, PU is therefore understood to mean not just polyurethane, but also polyisocyanurate, polyureas, and polyisocyanate reaction products containing uretdione, carbodiimide, allophanate, biuret and uretonimine groups. In the context of the present invention, polyurethane foam (PU foam) is understood to mean foam that is obtained as a product of reaction of a polyisocyanate component and a polyol component or compounds having isocyanate-reactive groups. In addition to the eponymous polyurethane, further functional groups may be formed here as well, examples being allophanates, biurets, ureas, carbodiimides, uretdiones, isocyanurates or uretonimines.

Rigid PU foam is an established technical term. The known and fundamental difference between flexible foam and rigid foam is that flexible foam shows elastic characteristics and hence deformation is reversible. By contrast, rigid foam is permanently deformed.

A particularly important concern associated with the provision of PU foams, especially rigid PU foams, is that of providing PU foams having good flame retardancy properties. For this reason, flame retardants are used. Flame-retardants are substances known per se that are used to limit, slow or prevent the spread of fires. In the known prior art, for example in “Plastics Flammability Handbook”, Carl Hanser Verlag, 3rd Edition, 2004, corresponding flame retardants are described which have flame-retardant properties and are suitable for use in PU foam.

Due to a large number of fire events, recent years have seen a very sharp increase in the global requirements placed on construction materials in the construction sector, and in particular on insulating materials, with regard to flame retardancy. This has the result that conventional rigid polyurethane foams can even no longer be used in countries with particularly high requirements, such as for example Japan or South Korea, since they do not meet the new standards in force. For instance, South Korea proscribes a total heat release of not more than 8 MJ/m² and a heat release rate of not more than 200 kW/m² in a cone calorimeter according to KS F ISO 5660-1:2015-03, and as a result the requirements there on rigid polyurethane foam are among the most stringent in the world.

In order to improve the flame retardancy properties of polyurethane foams, in particular rigid polyurethane foams, it is general practice to increase the amount of flame retardants used. However, the effects achievable thereby and the maximum possible use amounts are limited by the fact that the flame retardants have a negative impact on the overall properties of the foam, such as for example the mechanical strength thereof and/or the processing and production of the polyurethane foam. For instance, the use of triethyl phosphate (TEP), tris(2-chloroethyl) phosphate (TCEP) or tris(1-chloro-2-propyl) phosphate (TCPP) usually have a strongly plasticizing effect, which lowers the mechanical load-bearing capacity and limits the use amounts as a result. Other flame retardants, first and foremost those that are used as solid, entail considerable problems in terms of dispersion in the liquid starting materials and lead to an increase in the viscosity, which makes processing markedly more difficult or even impossible. Since many flame retardants also have ecological and toxicological drawbacks, it is sought to minimize the use thereof while simultaneously meeting all requirements.

Against this background, the specific object of the present invention was that of enabling the provision of PU foams, especially rigid PU foams, that satisfy increased requirements on flame retardancy, preferably according to KS F ISO 5660-1:2015-03, i.e. preferably a total heat release of not more than 8 MJ/m² and a heat release rate of not more than 200 kW/m² at a heating rate of 50 kW/m² and a test duration of 600 s, but have only a minor influence, if any, on the processing and the foam properties.

In this connection, it was surprisingly found, in the context of the present invention, that the use of a specific combination of compounds, as described in claim 1, in compositions for the production of PU foam, preferably rigid PU foam, especially rigid PU foam having an index of greater than 200, makes it possible to achieve the stated object. The processing and foam properties are affected only to a minor degree, if at all.

The abovementioned object is achieved by the subject matter of the invention. The subject matter of the invention is a composition for the production of PU foam, preferably rigid PU foam, comprising
at least one halogen-free polyester polyol and at least one halogenated polyol,
at least one physical blowing agent,
at least one flame retardant selected from
(a) the group of the phosphoric acid esters, preferably tris(1-chloro-2-propyl) phosphate (TCPP), triethyl phosphate (TEP) and/or tris(2-chloroethyl) phosphate (TCEP), especially TCPP and/or TEP,
and/or
(b) the group of the phosphonates, preferably dimethyl methanephosphonate (DMMP) and/or dimethyl propanephosphonate (DMPP),
red phosphorus,
   and at least one polyisocyanate component, wherein the composition has an index of at least 200. An upper limit for the index may for example with preference be 1000, preferably 500.

The subject matter of the invention is associated with a wide variety of advantages. For instance, it enables the provision of PU foams, preferably rigid PU foams, which meet particularly high requirements with regard to flame retardancy, especially as defined in KS F ISO 5660-1:2015-03. Advantageously, this is made possible without adversely affecting the other properties of the foam, in particular its mechanical properties. With regard to the provision of PU foams, preferably rigid PU foams, particularly fine-celled, uniform and low-defect foam structures are moreover made possible. The provision of corresponding PU foams having particularly good use properties is thus achieved. Overall, the invention enables simple processing in the context of foam production.

It is a particularly preferred embodiment of the invention when the red phosphorus (CAS No 7723-14-0) used according to the invention is microencapsulated. The microencapsulation of red phosphorus is well-known from the prior art. A possible variant is described, for example, in EP 1 262 453 A2.

It is a particularly preferred embodiment of the invention when the composition according to the invention additionally contains at least one smoke suppressant, preferably selected from the group consisting of antimony trioxide, zinc stannate, zinc hydroxystannate, zinc borate, calcium borate, zinc pyrophosphate, aluminium orthophosphate and aluminium phosphinate(s), with antimony trioxide and/or zinc borate being most preferred.

For the purposes of the present invention, when a component or at least one component, for example a chemical compound, is selected from a group “consisting of” two or more components, for example two or more chemical compounds, this means for the purposes of the present invention that each individual one of the components of this group mentioned may be selected or else mixtures from this group may be selected. Using the previously mentioned smoke suppressant as an example, this means that for example zinc stannate or for example antimony trioxide etc. may be selected, or for example antimony trioxide and zinc hydroxystannate or for example other mixtures may be selected.

The solid flame retardants used such as for example red phosphorus or smoke suppressants may for example be introduced into the reaction mixture via one of the two reaction components (i.e. via the polyol component or via the polyisocyanate component). Preference is in this case given to introduction via the polyol component.

It is a particularly preferred embodiment of the invention when in a composition according to the invention the at least one halogenated polyol is selected from the group consisting of
(i) brominated and/or chlorinated aliphatic or aromatic polyether diol and/or polyether triol, preferably brominated aliphatic or aromatic polyether diol and/or polyether triol,
and
(ii) polyester polyol based on tetrabromophthalate, preferably compound 1

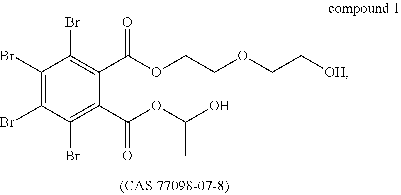 [SMILES: CC(O)OC(=O)c1c(Br)c(Br)c(Br)c(Br)c1C(=O)OCCOCCO]

with compound 1 being most preferred.

It is a further particularly preferred embodiment of the invention when the composition according to the invention contains compound 1 and TCPP and/or TEP and also additionally antimony trioxide and/or zinc borate.

It is further preferable for the composition according to the invention to contain at least one catalyst, preferably at least one trimerization catalyst, especially selected from the group consisting of ammonium salts and metal salts of 2-ethylhexanoic acid, of formic acid, of acetic acid, of propionic acid, of neodecanoic acid and of pivalic acid. This too corresponds to a further particularly preferred embodiment of the invention.

It is likewise preferable for the at least one physical blowing agent to be selected from the group consisting of dimethoxymethane, methyl formate, HFC-245fa, 1233zd, 1336mzz, cyclopentane, isopentane and n-pentane, particularly preferably selected from the group consisting of HFC-245fa, 1233zd, cyclopentane, isopentane and n-pentane. This likewise corresponds to a further particularly preferred embodiment of the invention.

It is likewise a particularly preferred embodiment of the invention when the composition according to the invention has the particular feature that, based on 100 parts by weight of the total halogen-free polyol component,
halogenated polyol in a total amount of 1 to 80 parts by weight, preferably 1.5 to 50 parts by weight, particularly preferably 2 to 40 parts by weight,
flame retardant, selected from (a) the group of the phosphoric acid esters, preferably TCPP, TEP and/or TCEP, and/or selected from (b) the group of the phosphonates, preferably DMMP and/or DMPP, in a total amount of 2 to 60 parts by weight, preferably 5 to 50 parts by weight, particularly preferably 5 to 40 parts by weight,
red phosphorus in a total amount of 1 to 45 parts by weight, preferably 2 to 35 parts by weight, particularly preferably 5 to 30 parts by weight,
optionally smoke suppressant, preferably selected from the group consisting of antimony trioxide, zinc stannate, zinc hydroxystannate, zinc borate, calcium borate, zinc pyrophosphate, aluminium orthophosphate and aluminium phosphinate(s), in a total amount of 0 to 40 parts by weight, preferably 1 to 35 parts by weight, particularly preferably 1.5 to 25 parts by weight,
   are present.

It is a further particularly preferred embodiment of the invention when the composition according to the invention has the particular feature that, based on 100 parts by weight of the total halogen-free polyol component,
compound 1 in a total amount of 1 to 80 parts by weight, preferably 1.5 to 50 parts by weight, particularly preferably 2 to 40 parts by weight,
TCPP and/or TEP in a total amount of 2 to 60 parts by weight, preferably 5 to 50 parts by weight, particularly preferably 5 to 40 parts by weight,
red phosphorus in a total amount of 1 to 45 parts by weight, preferably 2 to 35 parts by weight, particularly preferably 5 to 30 parts by weight,
antimony trioxide and/or zinc borate in a total amount of 1 to 40 parts by weight, preferably 1.5 to 35 parts by weight, particularly preferably 1.5 to 25 parts by weight,
   are present.

It is additionally particularly preferable for the composition according to the invention to additionally contain at least one foam stabilizer, preferably based on a polyether siloxane, especially in amounts of 0.1 to 4 parts, based on 100 parts of the total polyol component. This corresponds to a particularly preferred embodiment of the invention. Foam stabilizers that can be used in connection with the production of PU foams, preferably those based on a polyether siloxane, are known per se. Suitable foam stabilizers are also described hereinbelow.

It is a further particularly preferred embodiment of the invention when the composition according to the invention contains water and/or formic acid.

Of course, the composition according to the invention can if desired also contain further optional additives as typically used and known from the prior art in connection with the production of polyurethanes, especially PU foams.

The invention further provides a process for producing PU foams, preferably rigid PU foams, using foamable reaction mixtures containing a composition according to the invention, especially as defined in any of claims 1 to 10, or as described above, especially in the preferred embodiments.

The foamable reaction mixture may preferably also consist of the stated composition according to the invention.

A particularly preferred PU foam formulation, especially rigid PU foam formulation, in the context of the present invention has the composition given in Table 1:

TABLE 1
Composition of a preferred rigid PU foam formulation

| | Parts by |
|---|---|
| Component | weight |
| Polyol component (halogen-free) | >0 to 100 |
| Halogenated polyol | 1 to 50 |
| Amine catalyst | 0 to 5 |
| Trimerization catalyst | 0 to 10 |
| Foam stabilizer, preferably polyether siloxane | 0 to 5 |
| Water | 0 to 20 |
| Physical blowing agent | >0 to 50 |
| Flame retardant from (a) group of the | 1 to 50 |
| phosphoric acid esters and/or (b) group of the | |
| phosphonates | |
| Red phosphorus | 1 to 50 |
| Smoke suppressant | 0 to 50 |
| Further additives | 0 to 300 |
| Isocyanate index | 200 to 1000 |

The present invention yet further provides a PU foam, preferably rigid PU foam, produced by the abovementioned process according to the invention, in particular using a composition according to the invention.

It is a preferred embodiment of the invention when the PU foam, especially rigid PU foam, according to the invention has a foam density of 5 to 900 kg/m³, preferably 5 to 350 kg/m³, especially 10 to 200 kg/m³.

The present invention further provides for the use of PU foam, especially rigid PU foam, according to the invention, as mentioned above, as an insulating material and/or as a construction material, especially in construction applications, especially as spray foam or in the refrigeration sector, or as pipe lagging for pipes.

The invention has thus already been described in detail and those skilled in the art are familiar with the production of PU, especially PU foams, using at least one polyol component and at least one polyisocyanate component.

According to a particularly preferred embodiment of the invention, the composition according to the invention in particular contains the following constituents:
a) polyol component comprising at least one halogen-free polyester polyol and at least one halogenated polyol,
b) polyisocyanate component (at least one polyisocyanate and/or polyisocyanate prepolymer)
c) catalyst that catalyses the reaction of isocyanate groups with OH groups, NH groups, or other isocyanate-reactive groups and/or catalyses the reaction of isocyanate groups with one another
d) optionally foam stabilizer
e) blowing agent
f) flame retardant
g) optionally further additives.

Polyol components (a) used may be one or more organic compounds having OH groups, SH groups, NH groups and/or NH₂ groups, having a functionality of 1.8 to 8. The polyol component comprises at least one organic compound having at least two isocyanate-reactive groups selected from OH groups, SH groups, NH groups and/or NH₂ groups, especially OH groups.

A functionality that is not an integer, i.e. for example 1.8, may arise as a result of at least one compound having a relatively high functionality, for example of greater than or equal to 2, being mixed with at least one compound having a functionality of, for example, 1. This may happen in particular when using a polyisocyanate component (b) having a functionality of greater than 2 or additional crosslinkers as optional additives (g).

Appropriate compounds which may typically be used when producing PU are known to those skilled in the art and for example described in “Kunststoffhandbuch, Band 7, Polyurethane [Plastics Handbook, volume 7, Polyurethanes]”, Carl Hanser Verlag, 3rd Edition 1993, Chapter 3.1. It is customary to use compounds having OH numbers within a range from 10 to 1200 mg KOH/g.

Particularly preferred compounds are all polyether polyols and polyester polyols typically used for production of polyurethane systems, especially polyurethane foams.

Polyether polyols can be prepared by known methods, for example by polymerization of alkylene oxides, preferably ethylene oxide, 1,3-propylene oxide, 1,2- or 2,3-butylene oxide, and/or tetrahydrofuran.

Preferred polyester polyols are based on esters of polybasic aliphatic or aromatic carboxylic acids, preferably having 2 to 12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. Preferred polyester polyols can be obtained in particular by condensation of these polybasic carboxylic acids with polyhydric alcohols, preferably of diols or triols having 2 to 12, particularly preferably having 2 to 6, carbon atoms, preferably trimethylolpropane, ethylene glycol, diethylene glycol, propylene glycol, dipropylene glycol and/or glycerol.

In addition, it is possible to use polyether polycarbonate polyols, polyols based on natural oils (natural oil based polyols, NOPs; described in WO 2005/033167, US 2006/0293400, WO 2006/094227, WO 2004/096882, US 2002/0103091, WO 2006/116456, EP 1678232), filled polyols, prepolymer-based polyols and/or recycled polyols.

Recycled polyols are polyols that are obtained from the chemical recycling of polyurethanes, for example by solvolysis, for example glycolysis, hydrolysis, acidolysis or aminolysis. The use of recycled polyols constitutes a particularly preferred embodiment of the invention.

In the context of the present invention, the polyol component necessarily comprises at least one halogen-free polyester polyol and at least one halogenated polyol, as already described above.

Polyisocyanate components (b) used may generally be one or more polyisocyanates having two or more isocyanate groups. Suitable polyisocyanates for the purposes of the present invention are all organic isocyanates having two or more isocyanate groups, in particular the aliphatic, cycloaliphatic, arylaliphatic and preferably aromatic polyfunctional isocyanates known per se.

Examples that may be mentioned here are alkylene diisocyanates having 4 to 12 carbon atoms in the alkylene radical, for example dodecane 1,12-diisocyanate, 2-ethyltetramethylene 1,4-diisocyanate, 2-methylpentamethylene 1,5-diisocyanate, tetramethylene 1,4-diisocyanate, pentamethylene diisocyanate (PDI) and preferably hexamethylene 1,6-diisocyanate (HMDI), cycloaliphatic diisocyanates such as cyclohexane 1,3- and 1,4-diisocyanate and the corresponding isomer mixtures, methylene dicyclohexyl 4,4′-diisocyanate (H12MDI), isophorone diisocyanate (IPDI), methylcyclohexyl 2,4- and 2,6-diisocyanate and the corresponding isomer mixtures, and preferably aromatic diisocyanates and polyisocyanates such as toluene 2,4- and 2,6-diisocyanate (TDI) and the corresponding isomer mixtures, naphthalene diisocyanate, diethyltoluene diisocyanate, diphenylmethane 4,4′- or 2,2′- or 2,4′-diisocyanate (MDI) and polymethylene polyphenyl polyisocyanate (PMDI, “polymeric MDI”). The organic polyisocyanates may be used individually or in the form of mixtures thereof. It is likewise possible to use corresponding “oligomers” of the diisocyanates, such as the IPDI trimer based on the isocyanurate, biurets or uretdiones. Furthermore, the use of prepolymers based on the abovementioned isocyanates is possible. The mixture of MDI and more highly condensed analogues having an average functionality of 2 to 4 which is known as polymeric MDI (also referred to as “crude MDI”) is particularly suitable, as well as the various isomers of TDI in pure form or as isomer mixture. It is also possible to use isocyanates which have been modified by the incorporation of urethane, uretdione, isocyanurate, allophanate and other groups, known as modified isocyanates. Examples of particularly suitable isocyanates are also detailed for example in EP 1712578, EP 1161474, WO 00/58383, US 2007/0072951, EP 1678232 and WO 2005/085310, which are hereby fully incorporated by reference.

A preferred ratio of total polyisocyanate component and total polyol component, expressed as the index of the formulation, i.e. as stoichiometric ratio of isocyanate groups to isocyanate-reactive groups (e.g. OH groups, NH groups) multiplied by 100, is in the range from 200 to 1000 and preferably from 200 to 500. An index of 100 represents a molar ratio of reactive groups of 1:1. According to the invention, the claimed composition has an index of at least 200.

Suitable catalysts (c) which are usable for the production of polyurethanes, in particular PU foams, are known to those skilled in the art from the prior art. Usable compounds in the context of present invention are all compounds capable of catalysing the reaction of isocyanate groups with OH groups, NH groups or other isocyanate-reactive groups, and/or the reaction of isocyanate groups with one another. Compounds that catalyse the reaction of the isocyanate groups with one another, in particular the trimerization reaction, are also known to those skilled in the art as trimerization catalysts and are described, for example, in EP 1 745 847 A1.

It is possible here to use the customary catalysts known from the prior art, including for example amines (cyclic, acyclic; monoamines, diamines, oligomers having one or more amino groups), ammonium compounds, organometallic compounds and/or metal salts, preferably those of tin, iron, bismuth, potassium and/or zinc. In particular, catalysts used may be mixtures of two or more compounds of this kind.

Foam stabilizers (d) and the use thereof in the production of PU foams are known to those skilled in the art. The use of foam stabilizers is optional; preference is given to using one or more foam stabilizers. Foam stabilizers that may be used are in particular surface-active compounds (surfactants). Preference is given to using foam stabilizers in the production of PU foams. They may be used to optimize the desired cell structure and the foaming process. In the context of the present invention, it is possible in particular to use one or more of the known Si-containing compounds that assist foam production (stabilization, cell regulation, cell opening, etc.). These compounds are sufficiently well known from the prior art. It is particularly preferably possible to use at least one foam stabilizer based on a polyether siloxane. Corresponding siloxane structures which are usable in the context of the present invention are described, for example, in the following patent documents, although these describe use only in conventional PU foams (e.g. as moulded foam, mattress, insulation material, construction foam, etc.): CN 103665385, CN 103657518, CN 103055759, CN 103044687, US 2008/0125503, US 2015/0057384, EP 1520870 A1, EP 1211279, EP 0867464, EP 0867465, EP 0275563. As well as surface-active Si-containing compounds, Si-free surfactants may also be used. For example, EP2295485 A1 describes the use of lecithin and U.S. Pat. No. 3,746,663 the use of vinylpyrrolidone-based structures as foam stabilizer for the production of rigid PU foam. Further Si-free foam stabilizers are described for example in EP 2511328 B1, DE 1020011007479 A1, DE 3724716 C1, EP 0734404, EP 1985642, DE 2244350 and U.S. Pat. No. 5,236,961.

Blowing agents (e) and the use thereof in the production of PU foams are known to those skilled in the art. The use of a blowing agent (e) or of a combination of two or more blowing agents (e) depends in principle on the nature of the foaming process used, on the nature of the system and on the use for the PU foam obtained. According to the invention, at least one physical blowing agent is used. Chemical blowing agents may also additionally be used. Depending on the amount of blowing agent used, a foam having high or low density is produced. For instance, foams can be produced having densities of 5 kg/m³ to 900 kg/m³, preferably 5 to 350, particularly preferably 8 to 200 kg/m³, especially 8 to 150 kg/m³.

Physical blowing agents that may be used are one or more of the appropriate compounds having suitable boiling points, and mixtures thereof. Physical blowing agents that can be used with preference have already been mentioned.

Chemical blowing agents used may be one or more compounds that react with NCO groups with the release of gases, for example water or formic acid, or which release gases during the reaction as a result of the rise in temperature, for example sodium hydrogencarbonate. It is a particularly preferred embodiment of the invention when, in addition to the physical blowing agent, the composition according to the invention contains water and/or formic acid as chemical blowing agent.

As flame retardant (f), preference is given, as already described, to at least one compound from the group of the phosphoric acid esters, preferably TCPP, TEP and/or TCEP and/or from the group of the phosphonates, preferably DMMP and/or DMPP, and additionally red phosphorus, preferably microencapsulated red phosphorus.

As optional additives (g), it is possible to use one or more of the substances which are known from the prior art and are used in the production of polyurethanes, especially PU foams, for example crosslinkers, chain extenders, stabilizers against oxidative degradation (known as antioxidants), biocides, cell-refining additives, nucleating agents, cell openers, solid fillers, antistatic additives, thickeners, dyes, pigments, colour pastes, fragrances, and/or emulsifiers etc.

The composition according to the invention furthermore optionally contains what are known as smoke suppressants. Smoke suppressants that can be used with preference have already been mentioned. These advantageously have the particular feature that they, used alone, do not have any direct effect on flame retardancy, but in some cases significantly boost the effect of other flame retardants and/or reduce the development of smoke. Smoke suppressants are known to those skilled in the art and include, for example, antimony trioxide, zinc hydroxystannate, zinc stannate, zinc borate, calcium borate or antimony pentoxide. These are also described, for example, in Weil, Edward D. Levchik, Sergei V. (2016) Flame Retardants for Plastics and Textiles—Practical Applications (2nd Edition); Carl Hanser Verlag, chapter 4 or WO 2009109318 A1 or Su et al., Polymer degradation and stability, 2012; 97 (11): 2128-2135 or Horrocks et al., Journal of Fire Sciences, 2010; 28 (3): 217-248.

Unless the opposite is apparent from this description, it is possible to combine any preferred or particularly preferred embodiment of the invention with one or more of the other preferred or particularly preferred embodiments of the invention.

The process according to the invention for producing PU foams can be conducted by any known methods, for example by manual mixing or preferably by means of foaming machines. If the process is conducted using foaming machines, it is possible to use high-pressure or low-pressure machines. The process according to the invention can be carried out either batchwise or continuously and it is possible for example to use 1K, 1.5K or 2K systems as described in EP3717538 A1, U.S. Pat. No. 7,776,934 B2, EP1400547 B1 or EP2780384 B2.

The subject matter of the invention is described below by way of example, without any intention of restricting the invention, the scope of application of which is apparent from the entirety of the description and the claims, to these exemplary embodiments.

Where ranges, general formulae or classes of compounds are stated, these are intended to encompass not only the corresponding ranges or groups of compounds explicitly mentioned but also all subranges and subgroups of compounds that can be obtained by removing individual values (ranges) or compounds. Where documents are cited in the context of the present description, the entire content thereof, particularly with regard to the subject matter that forms the context in which the document has been cited, is intended to form part of the disclosure content of the present invention. Unless stated otherwise, percentages are in weight percent. Where average values are stated, these are numerical averages unless stated otherwise. Where parameters that have been determined by measurement are stated, the measurements have been carried out at a temperature of 23° C. and standard pressure, unless stated otherwise.

### EXAMPLES

The performance comparison was carried out using the formulations presented in Tables 2 and 3. The comparative foaming operations were carried out by manual mixing. To this end, polyol component, catalysts, water, foam stabilizer, flame retardant, physical blowing agent and optionally further additives were weighed into a beaker and mixed by means of a disc stirrer (diameter 6 cm) at 1000 rpm for 30 s (batch size 500 g). The beaker was reweighed to determine the amount of blowing agent that had evaporated during the mixing operation and this was replenished. The pMDI (“polymeric MDI”) was then added, and the mixture was stirred with the described stirrer at 3000 rpm for 5 s and immediately transferred into a 25 cm×50 cm×7 cm aluminium mould lined with polyethylene film and thermostatted to 60° C. After 10 min, the foams were demoulded. One day after foaming, the foams were analysed. The surface of the upper and lower side and the internal defects were assessed subjectively on a scale from 1 to 10, where 10 represents an (idealized) defect-free foam and 1 a very significantly defective foam.

The fire characteristics were determined using a cone calorimeter in accordance with KS F ISO 5660-1:2015-03. To this end, 3 test specimens each measuring 10×10×5 cm were cut from each foam and the total heat release (THR in MJ/m²) within 600 s, the peak heat release rate (PHRR in kW/m²) within 600 s, the mass loss during the burning time (in %) and the burning time (in s), more precisely, the time between ignition and extinguishing of the flame, were measured. The heating rate was 50 KW/m². The arithmetic average was determined from the values for the 3 test specimens. The test is considered to be passed when a THR<8 MJ/m² and PHRR<200 KW/m² were achieved. The results are presented in Tables 4 and 5.

TABLE 2
Rigid PU foam formulations (composition in parts by weight)

| Formulation | 1 | 2 | 3 | 4 | 5 | 6 | 7 | 8 | 9 | 10 | 11 |
|---|---|---|---|---|---|---|---|---|---|---|---|
| According to the invention | | | | | | x | x | x | x | x | x |
| Polyester polyol* | 90 | 70 | 70 | 80 | 80 | 70 | 70 | 70 | 70 | 70 | 70 |
| Castor oil | | 11 | 11 | 11 | 11 | 11 | 11 | 11 | 11 | 11 | 11 |
| TEGOSTAB ® B 84504 ** | 2 | 2 | 2 | 2 | 2 | 2 | 2 | 2 | 2 | 2 | 2 |
| POLYCAT ® 5 *** | 0.3 | 0.3 | 0.3 | 0.3 | 0.3 | 0.3 | 0.3 | 0.3 | 0.3 | 0.3 | 0.3 |
| KOSMOS ® 70 LO **** | 3.0 | 3.0 | 3.0 | 3.0 | 3.0 | 3.0 | 3.0 | 3.0 | 3.0 | 3.0 | 3.0 |
| KOSMOS ® 33 **** | 1.5 | 1.5 | 1.5 | 1.5 | 1.5 | 1.5 | 1.5 | 1.5 | 1.5 | 1.5 | 1.5 |
| Water | 0.4 | 0.4 | 0.4 | 0.4 | 0.4 | 0.4 | 0.4 | 0.4 | 0.4 | 0.4 | 0.4 |
| TCPP | 20 | | | 20 | 20 | 20 | 20 | 20 | 20 | 20 | 20 |
| TEP | | | | | | | | | | | |
| Red phosphorus | | 9 | \|9 | 9 | 9 | 9 | 9 | 9 | 9 | 9 | 9 |
| (microencapsulated) | | | | | | | | | | | |
| Compound 1 | 10 | 10 | | | | 10 | 10 | 10 | 10 | 10 | 10 |
| Halogenated polyol 2***** | | | 10 | | | | | | | | |
| Antimony trioxide | | | | | 10 | | 10 | | | | |
| Zinc borate | | | | | | | | 10 | | | |
| Aluminium | | | | | | | | | 10 | | |
| diethylphosphinate | | | | | | | | | | | |
| Aluminium orthophosphate | | | | | | | | | | 10 | |
| Zinc pyrophosphate | | | | | | | | | | | 10 |
| HFC-245fa | 49 | 49 | 49 | 49 | 49 | 49 | 49 | 49 | 49 | 49 | 49 |
| HFO-1233zd | | | | | | | | | | | |
| Cyclopentane | | | | | | | | | | | |
| pMDI (Voranate ® M 229) | 303 | 303 | 303 | 303 | 303 | 303 | 303 | 303 | 303 | 303 | 303 |

TABLE 3
Rigid PU foam formulations (composition in parts by weight)

| Formulation | 12 | 13 | 14 | 15 | 16 | 17 | 18 | 19 | 20 | 21 |
|---|---|---|---|---|---|---|---|---|---|---|
| According to the invention | x | x | x | x | x | x | x | x | | |
| Polyester polyol* | 70 | 70 | 70 | 70 | 70 | 70 | 70 | 70 | 70 | 70 |
| Castor oil | 11 | 11 | 11 | 11 | 11 | 11 | 11 | 11 | 11 | 11 |
| TEGOSTAB ® B 84504** | 2 | 2 | 2 | 2 | 2 | 2 | 2 | 2 | 2 | 2 |
| POLYCAT ® 5*** | 0.3 | 0.3 | 0.3 | 0.3 | 0.3 | 0.3 | 0.3 | 0.3 | 0.3 | 0.3 |
| KOSMOS ® 70 LO**** | 3.0 | 3.0 | 3.0 | 3.0 | 3.0 | 3.0 | 3.0 | 3.0 | 3.0 | 3.0 |
| KOSMOS ® 33**** | 1.5 | 1.5 | 1.5 | 1.5 | 1.5 | 1.5 | 1.5 | 1.5 | 1.5 | 1.5 |
| Water | 0.4 | 0.4 | 0.4 | 0.4 | 0.4 | 0.4 | 0.4 | 0.4 | 0.4 | 0.4 |
| TCPP | | | 20 | 20 | 20 | 20 | 20 | 20 | 20 | 20 |
| TEP | 20 | 20 | | | | | | | | |
| Red phosphorus | 9 | 9 | 9 | 9 | 9 | 9 | 9 | 9 | 9 | 9 |
| (microencapsulated) | | | | | | | | | | |
| Compound 1 | 10 | 10 | | | 10 | 10 | 10 | 10 | 10 | 10 |
| Halogenated polyol 2***** | | | 10 | 10 | | | | | | |
| Antimony trioxide | | 10 | | 10 | | 10 | | 10 | | 10 |
| Zinc borate | | | | | | | | | | |
| Aluminium | | | | | | | | | | |
| diethylphosphinate | | | | | | | | | | |
| Aluminium orthophosphate | | | | | | | | | | |
| Zinc pyrophosphate | | | | | | | | | | |
| HFC-245fa | 49 | 49 | 49 | 49 | | | | | 28 | 28 |
| HFO-1233zd | | | | | 48 | 48 | | | | |
| Cyclopentane | | | | | | | 19 | 19 | | |
| pMDI (Voranate M 229) | 303 | 303 | 303 | 303 | 303 | 303 | 303 | 303 | 111 | 111 |

*Diethylene glycol phthalic anhydride-based polyester polyol with a hydroxyl value of 315 mg KOH/g
**Polyether siloxane-based foam stabilizer from Evonik Operations GmbH
***Amine catalyst from Evonik Operations GmbH
****Trimerization catalyst from Evonik Operations GmbH
*****Brominated aliphatic polyether triol with a hydroxyl number of 330 mg KOH/g and 31.5% by weight bromine

TABLE 4
Physical properties and fire characteristics

| Formulation | 1 | 2 | 3 | 4 | 5 | 6 | 7 | 8 | 9 | 10 | 11 |
|---|---|---|---|---|---|---|---|---|---|---|---|
| Density (kg/m³) | 39.7 | 38.4 | 38.1 | 40.6 | 41.2 | 39.1 | 40.8 | 40.6 | 40.5 | 41.2 | 39.8 |
| Upper side | 6.5 | 6.0 | 6.5 | 6.0 | 6.0 | 6.0 | 5.5 | 6.5 | 6.0 | 6.0 | 6.0 |
| Lower side | 6.0 | 5.5 | 5.5 | 5.5 | 5.0 | 5.5 | 5.5 | 5.5 | 5.0 | 5.5 | 5.5 |
| Internal defects | 7.0 | 7.0 | 7.0 | 6.5 | 6.5 | 6.5 | 6.0 | 6.5 | 6.5 | 6.0 | 6.5 |
| THR (MJ/m²) | >8.0 | >8.0 | >8.0 | >8.0 | >8.0 | 6.3 | 4.9 | 6.1 | 4.2 | 4.5 | 4.9 |
| PHHR (kW/m²) | 56.7 | 57.0 | 60.5 | 52.1 | 55.2 | 31.5 | 24.8 | 26.1 | 22.5 | 24.2 | 27.1 |
| Mass loss (%) | 40.9 | 35.1 | 39.7 | 18.1 | 19.4 | 6.6 | 3.2 | 5.1 | 3.8 | 4.9 | 6.1 |
| Burning time (s) | 89 | 52 | 67 | 34 | 38 | 13 | 7 | 14 | 9 | 9 | 12 |

TABLE 5
Physical properties and fire characteristics

| Formulation | 12 | 13 | 14 | 15 | 16 | 17 | 18 | 19 | 20 | 21 |
|---|---|---|---|---|---|---|---|---|---|---|
| Density (kg/m³) | 39.2 | 40.2 | 40.0 | 40.7 | 38.4 | 39.3 | 44.1 | 46.0 | 41.5 | 41.7 |
| Upper side | 5.5 | 5.5 | 6.5 | 6.0 | 6.0 | 6.0 | 6.5 | 6.5 | 2.0 | 2.0 |
| Lower side | 5.5 | 5.0 | 6.0 | 6.0 | 5.5 | 5.5 | 5.0 | 5.0 | 2.0 | 2.0 |
| Internal defects | 6.5 | 6.5 | 7.0 | 7.0 | 6.5 | 6.5 | 7.0 | 7.0 | 2.0 | 2.0 |
| THR (MJ/m²) | 6.2 | 5.4 | 6.4 | 5.5 | 6.4 | 4.8 | 7.8 | 7.6 | — | — |
| PHHR (kW/m²) | 42.0 | 35.9 | 32.1 | 26.9 | 34.1 | 31.0 | 74.4 | 68.5 | — | — |
| Mass loss (%) | 10.1 | 7.9 | 9.1 | 9.2 | 7.9 | 7.6 | 25.0 | 22.1 | — | — |
| Burning time (s) | 21 | 13 | 21 | 18 | 15 | 15 | 88 | 80 | — | — |

The results show that the foams, based on the composition according to the invention as opposed to the selected references not in accordance with the invention, meet the flame retardancy requirements and have only a minor influence, if any, on the relevant foam properties as a result of the use of the composition according to the invention. The considerably reduced mass loss and the shorter burning time of the compositions according to the invention is additionally an indicator for a considerably reduced smoke generation, since less material is passing into the gas phase. Tests 20 and 21 yielded very coarse, unusable foams, and as a result burning tests could not be conducted.

1-13. (canceled)

14. A composition for the production of polyurethane (PU) foam comprising:
a) at least one halogen-free polyester polyol and at least one halogenated polyol;
b) at least one physical blowing agent;
c) at least one flame retardant selected from:
i) one or more phosphoric acid esters; and/or
ii) one or more phosphonates;
d) red phosphorus; and
e) at least one polyisocyanate component;
wherein the composition has an index of at least 200.

15. The composition of claim 14, wherein said flame retardant is selected from the group consisting of: tris(1-chloro-2-propyl) phosphate, triethyl phosphate, and/or tris(2-chloroethyl) phosphate.

16. The composition of claim 14, wherein said phosphonate is dimethyl methanephosphonate or dimethyl propanephosphonate.

17. The composition of claim 14, further comprising at least one smoke suppressant.

18. The composition of claim 17, wherein said at least one smoke suppressant is selected from the group consisting of: antimony trioxide, zinc stannate, zinc hydroxystannate, zinc borate, calcium borate, zinc pyrophosphate, aluminium orthophosphate, and aluminium phosphinate.

19. The composition of claim 14, wherein the at least one halogenated polyol is a brominated and/or chlorinated aliphatic or aromatic polyether diol and/or a polyether triol.

20. The composition of claim 14, wherein the at least one halogenated polyol is compound 1:

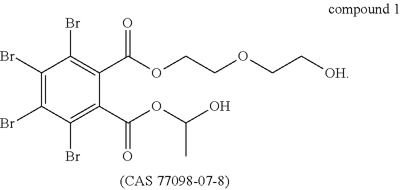 [SMILES: CC(O)OC(=O)c1c(Br)c(Br)c(Br)c(Br)c1C(=O)OCCOCCO]

21. The composition of claim 14, wherein said composition comprises:
compound 1;
tris(1-chloro-2-propyl) phosphate and/or triethyl phosphate; and
antimony trioxide and/or zinc borate.

22. The composition of claim 14, wherein said composition further comprises a catalyst.

23. The composition of claim 14, wherein said composition comprises a trimerization catalyst.

24. The composition of claim 23, wherein said trimerization catalyst is selected from the group consisting of: ammonium salts and metal salts of 2-ethylhexanoic acid, of formic acid, of acetic acid, of propionic acid, of neodecanoic acid and of pivalic acid.

25. The composition of claim 14, wherein the at least one physical blowing agent is selected from the group consisting of dimethoxymethane, methyl formate, HFC-245fa, 1233zd, 1336mzz, cyclopentane, isopentane and n-pentane.

26. The composition of claim 14, wherein the at least one physical blowing agent is HFC-245fa, 1233zd, cyclopentane, isopentane or n-pentane.

27. The composition of claim 14, wherein, based on 100 parts by weight of the total halogen-free polyol component, the composition comprises:
a halogenated polyol in a total amount of 1 to 80 parts by weight;
flame retardant in a total amount of 2 to 60 parts by weight;
red phosphorus in a total amount of 1 to 45 parts by weight;
optionally a smoke suppressant, in a total amount of 0 to 40 parts by weight.

28. The composition of claim 27, wherein, based on 100 parts by weight of the total halogen-free polyol component, the composition comprises:
halogenated polyol in a total amount of 2 to 40 parts by weight;
flame retardant, selected from: tris(1-chloro-2-propyl) phosphate, triethyl phosphate and/or tris(2-chloroethyl) phosphate, dimethylmethanephosphonate and/or dimethyl propanephosphonate, in 5 to 40 parts by weight;
red phosphorus in a total amount of 5 to 30 parts by weight;
optionally smoke suppressant, selected from the group consisting of antimony trioxide, zinc stannate, zinc hydroxystannate, zinc borate, calcium borate, zinc pyrophosphate, aluminium orthophosphate and aluminium phosphinate(s), in a total amount 1.5 to 25 parts by weight.

29. The composition of claim 14, wherein, based on 100 parts by weight of the total halogen-free polyol component, the composition comprises:
compound 1 in a total amount of 1 to 80 parts by weight;
tris(1-chloro-2-propyl) phosphate and/or triethyl phosphate in a total amount of 2 to 60 parts by weight;
red phosphorus in a total amount of 1 to 45 parts by weight; and
antimony trioxide and/or zinc borate in a total amount of 1 to 40 parts by weight.

30. The composition of claim 14, wherein, based on 100 parts by weight of the total halogen-free polyol component, the composition comprises:
compound 1 in a total amount of 2 to 40 parts by weight;
tris(1-chloro-2-propyl) phosphate and/or triethyl phosphate in a total amount of 5 to 40 parts by weight;
red phosphorus in a total amount of 5 to 30 parts by weight;
antimony trioxide and/or zinc borate in a total amount of 1.5 to 25 parts by weight.

31. The composition of claim 30, further comprising a foam stabilizer.

32. The composition of claim 31, wherein the foam stabilizer comprises a polyether siloxane, in an amount of 0.1 to 4 parts, based on 100 parts of the total polyol component.

33. The composition of claim 32, wherein the composition comprises water and/or formic acid.
